(19) United States
(12) Patent Application Publication
(10) Pub. No.: US 2017/0249404 A1
(43) Pub. Date: Aug. 31, 2017

(54) MITIGATING LATENCY ERRORS IN DISTRIBUTED SYSTEMS

(71) Applicants: Alliance for Sustainable Energy, LLC, Golden, CO (US); Colorado State University Research Foundation, Fort Collins, CO (US)

(72) Inventors: James L. CALE, Fort Collins, CO (US); Emiliano DALL'ANESE, Arvada, CO (US); Brian Benjamin JOHNSON, Denver, CO (US); Peter Michael YOUNG, Fort Collins, CO (US); Daniel ZIMMERLE, Fort Collins, CO (US); Leah Michelle HOLTON, Denver, CO (US)

(21) Appl. No.: 15/443,390

(22) Filed: Feb. 27, 2017

Related U.S. Application Data
(60) Provisional application No. 62/299,801, filed on Feb. 25, 2016.

(51) Int. Cl. G06F 17/50

(52) U.S. Cl. CPC G06F 17/5009

(57) ABSTRACT

An example system includes a simulation system that emulates a first portion of an electrical system and controls, based on the first portion, electrical inputs to a device under test. The system also includes an observation device, operatively coupled to the simulation system, that receives a delayed version of a remote emulation value, which represents a second portion of the electrical system. The remote emulation value is generated by another, physically separate simulation system. The observation device is further configured to determine, based on the delayed version of the remote emulation value and a model of the second portion, a respective real-time estimation of the remote emulation value, and output, to the simulation system, the respective real-time estimation. The simulation system is further configured to emulate the first portion based on the respective real-time estimation of the remote emulation value.

### CROSS-REFERENCE TO RELATED APPLICATION

This application claims the benefit of U.S. Provisional Application No. 62/299,801, filed Feb. 25, 2016, the entire content of which is incorporated herein by reference.

### CONTRACTUAL ORIGIN

This invention was made with government support under grant DE-AC36-08GO28308 awarded by the United States Department of Energy. The government has certain rights in the invention.

### BACKGROUND

Various laboratories, industry players, and other institutions have developed sophisticated and specialized processing and experimentation equipment. For instance, power hardware-in-the-loop (PHIL) experimentation provides the capability to simulate interaction between real, physical devices and a large-scale simulated power grid. Not all interested parties may have the financial or technical means to build and/or maintain such equipment, however.

The Internet and other computer networks have made large strides in allowing the sharing of information between two remote parties. Thus, those interested in using specialized processing and experimentation equipment may not have to move at all, regardless of location. However, all communications networks are associated with an inherent latency—information does not travel instantaneously.

### SUMMARY

In one example, a system includes a first simulation system configured to emulate a first portion of an electrical system and control, based on the first portion of the electrical system, electrical inputs to a device under test. The system also includes a first observation device operatively coupled to the first simulation system. The first observation device is configured to receive a delayed version of at least one remote emulation value, the at least one remote emulation value representing a second portion of the electrical system. The at least one remote emulation value is generated by a second simulation system that is physically separate from the first simulation system. The first observation device is further configured to determine, based on the delayed version of the at least one remote emulation value and a model of the second portion of the electrical system, a respective real-time estimation of the at least one remote emulation value, and output, to the first simulation system, the respective real-time estimation of the at least one remote emulation value. The first simulation system is further configured to emulate the first portion of the electrical system based on the respective real-time estimation of the at least one remote emulation value.

In another example, a device includes at least one processor configured to receive a delayed version of at least one remote emulation value, the at least one remote emulation value representing a first portion of an electrical system. The at least one remote emulation value is generated by a simulation system that is physically separate from the computing device. The at least one processor is further configured to determine, based on the delayed version of the at least one remote emulation value and a model of the first portion of the electrical system, a respective real-time estimation of the at least one remote emulation value, emulate, based on the respective real-time estimation of the at least one remote emulation value, a second portion of the electrical system, and control, based on the second portion of the electrical system, electrical inputs to a device under test.

In another example, a method includes receiving, by a computing device comprising at least one processor, a delayed version of at least one remote emulation value, the at least one remote emulation value representing a first portion of an electrical system. The at least one remote emulation value is generated by a simulation system that is physically separate from the computing device. The method further includes determining, by the computing device and based on the delayed version of the at least one remote emulation value and a model of the first portion of the electrical system, a respective real-time estimation of the at least one remote emulation value, emulating, by the computing device and based on the respective real-time estimation of the at least one remote emulation value, a second portion of the electrical system, and controlling, by the computing device and based on the second portion of the electrical system, electrical inputs to a device under test.

The details of these and/or one or more additional examples are set forth in the accompanying drawings and the description below. Other features, objects, and advantages will be apparent from the description and drawings, and from the claims.

### BRIEF DESCRIPTION OF DRAWINGS

FIG. 1 is a schematic diagram illustrating an example configuration for a single hardware-in-the-loop (HIL) simulation.

FIG. 2 is a schematic diagram illustrating an example configuration for mitigating latency errors in distributed HIL simulation systems, in accordance with one or more aspects of the present disclosure.

FIG. 3 is a schematic diagram illustrating another example configuration for mitigating latency errors in distributed HIL simulation systems, in accordance with one or more aspects of the present disclosure.

FIG. 4 is a block diagram illustrating one example of a simulation system configured to mitigate latency errors, in accordance with one or more aspects of the present disclosure.

FIGS. 5A-5C are schematic diagrams illustrating an example distributed simulation of an electrical circuit, in accordance with one or more aspects of the present disclosure.

FIG. 6 is a graphical plot illustrating an input reference signal for the example distributed simulation of the circuit shown in FIG. 5C, in accordance with one or more aspects of the present disclosure.

FIG. 7 is a set of graphical plots illustrating latency error mitigation results from the example distributed simulation of the circuit shown in FIG. 5C, in accordance with one or more aspects of the present disclosure.

FIG. 8 is a set of graphical plots illustrating mitigated latency error values for the example distributed simulation of the circuit shown in FIG. 5C, in accordance with one or more aspects of the present disclosure.

FIG. 9 is a set of graphical plots illustrating latency error mitigation results from the example distributed simulation in hardware of the circuit shown in FIG. 5C, in accordance with one or more aspects of the present disclosure.

FIG. 10 is a flow diagram illustrating example operations for mitigating latency errors in distributed systems, in accordance with one or more aspects of the present disclosure.

### DETAILED DESCRIPTION

The present disclosure provides systems, devices, and methods that mitigate latency errors in distributed networks, such as those used to perform remote hardware-in-the-loop (HIL) experiments. As one example, system may include two physically disparate simulation systems, each configured to emulate different portions of an electrical system. Each simulation system may include an “observer,” configured to predict a current value of the other simulation system's emulated state, based on a model of the portion emulated by the other simulation system and a delayed indication of the other system's emulated state. The observer may provide the predicted current value to its corresponding simulation system which may use the predicted current value in emulation.

By predicting a current value of a physically disparate simulation system's state, the observer may reduce or even eliminate the potential for latency-based error. Such error may arise, for example, when the distance between the two simulation systems is large, when the congestion between the two simulation systems is limited or congested, or when the amount of data being shared between the two simulation systems is large. Reducing latency-error may allow for use of specialized facilities without the need to physically transport fragile or heavy components while ensuring that results are more accurate.

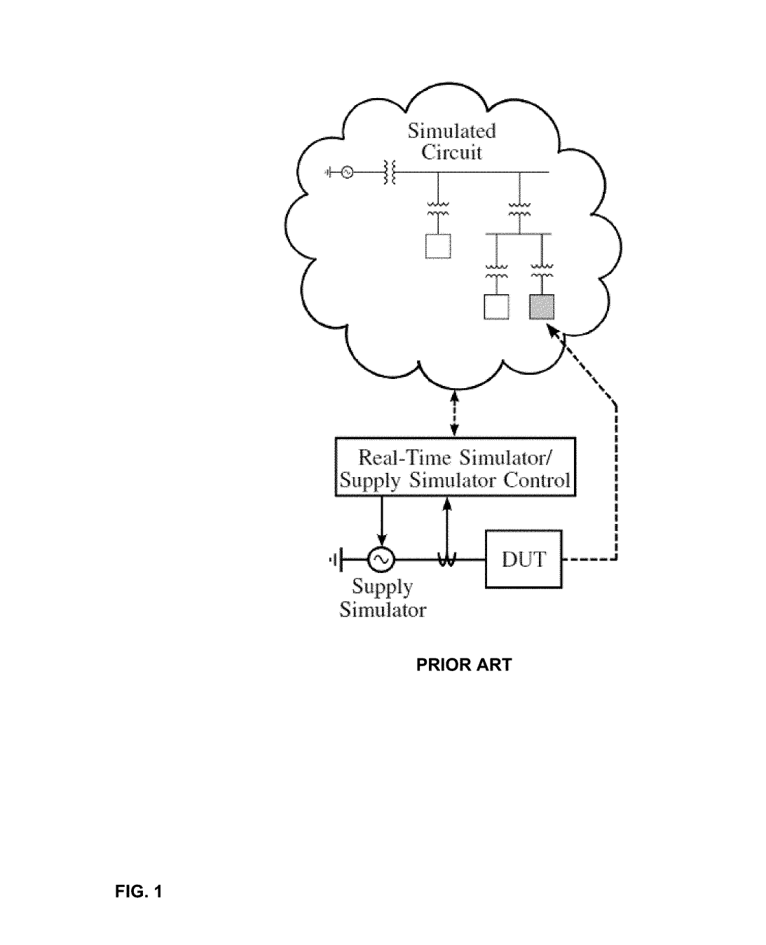

FIG. 1 is a schematic diagram illustrating an example configuration for a single HIL simulation. HIL systems, in general, allow for realistic evaluation of physical hardware in the context of a modeled system. Using real-time simulation, models are executed and exchange signals with a physical device under test (DUT) in a closed-loop fashion.

In the example of FIG. 1, the supply simulator is a controllable ac power supply that is physically connected to the DUT. The real-time simulator (“Real-Time Simulator/Supply Simulator Control”) computes the output of the simulated circuit model (shown as the bubbled area in FIG. 1) and provides control signals to the supply simulator. During operation, measurements from the experiment (e.g., the response of the DUT) are fed back to the simulated circuit model running on the real-time simulator. In this way, the dynamic response of the DUT inside the circuit model can be obtained. That is the DUT appears to be inside the circuit model (depicted as the gray box in FIG. 1).

Single location, real-time HIL systems, including controller HIL (CHIL) systems and power HIL (PHIL) systems, have been developed extensively in the art for closed-loop simulations. Examples include simulation of physical controllers and power devices and systems for investigating demand side management techniques for providing grid ancillary services. Some such simulations may include multi-physics domains. Although HIL experimentation is not a new concept, research has been focusing on ways to virtually connect multiple HIL experiments—consisting of both physical hardware and simulation at multiple locations—by connecting experiments through a communication link between real-time processors. Such systems, including two or more of the individual HIL systems depicted in FIG. 1, are referred to herein as “distributed” HIL systems. In other words, a distributed HIL system includes two or more individual HIL systems that are physically separated yet exchange state information through one or more communication networks to execute a virtually-connected, closed-loop simulation.

Several national and international laboratories, universities and industrial companies are pursuing these virtually connected testbeds, whereby individual HIL experiments at distant locations share state information to emulate larger-scale connected systems. Motivation for such an arrangement is driven in part by the desire to share resources that are physically separated (often over large geographical distances) and include, in such experiments, devices or systems that are too difficult to relocate or model. For instance, a recent experiment analyzing high penetration photovoltaics (PV) on an electrical distribution feeder was performed between two U.S. national laboratories through the use of distributed HIL, where a large-scale grid simulation at one laboratory in the state of Washington was virtually connected with a set of physical, residential PV inverters operating at the other laboratory, in the state of Colorado.

Communication latencies between HIL instances in a distributed HIL system are an important factor in ensuring the desired bandwidth of the emulated experiment is met. However, related-art research has not adequately addressed mitigation of communication latencies inherent in such remotely connected HIL systems. As the complexity, number, and physical distances between remotely connected HIL systems increase, it is expected that communication delays will begin to adversely impact the resolutions possible in multi-system (distributed) HIL experiments. In particular, sampling times between remote processors place a fundamental limitation on the effective bandwidth of the combined experiment due to the Nyquist criterion. Communication latencies from network traffic or stringent security firewalls at potential host locations can also be a significant source of delay. Advanced methods for mitigating communication latencies are needed to enable larger and more complex virtually connected testbeds.

In contrast to related art systems and methods, the systems, methods, and devices disclosed herein may leverage actual or synthesized observers in order to implement dynamical systems with delayed measurements. Such observers may mitigate at least a portion of the effects of communication delays inherent in, for example, a distributed HIL system. The upshot of the techniques described herein is that the output of the observer will, theoretically, asymptotically converge to the values of the actual (non-delayed) system output. In the HIL setup, this implies that the observer would closely track the output of the system/device under test in the remote location. Thus, the two remote systems/devices would operate closer to how they would operate if they were directly electrically connected (e.g., collocated). As a result, the techniques described herein may improve the overall accuracy, speed, and/or quality of simulations when, for example, multiple, physically-separated instances of the HIL system depicted in FIG. 1 are connected through one or more communication links.

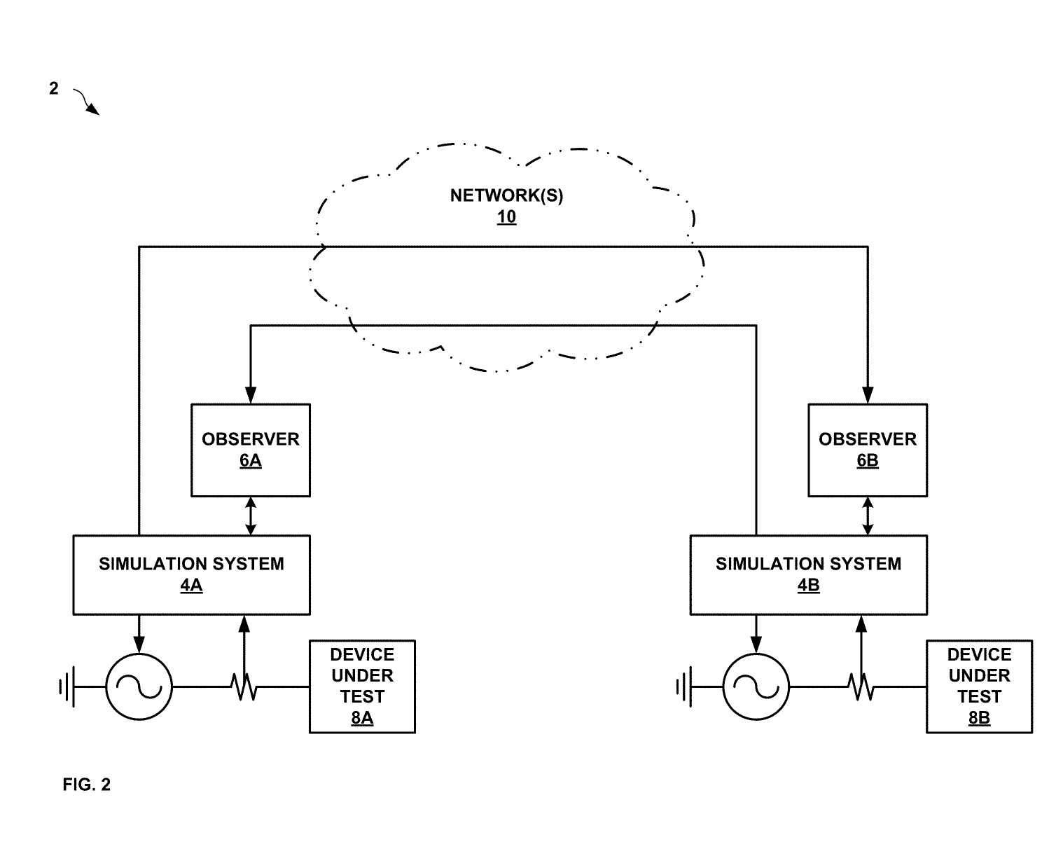

FIG. 2 is a schematic diagram illustrating an example configuration for mitigating latency errors in distributed HIL simulation systems, in accordance with one or more aspects of the present disclosure. Specifically, FIG. 2 illustrates system 2, which includes simulation systems 4A and 4B (collectively “simulation systems 4”), observers 6A and 6B (collectively “observers 6”) and devices under test 8A and 8B (collectively “devices under test 8”). The example of FIG. 2 represents only one configuration for mitigating latency errors, and various other configurations may be used in accordance with the techniques described herein.

In the example of FIG. 2, simulation systems 4 are real-time simulators configured to emulate a portion of an electrical system and control, based on the first portion of the electrical system, electrical inputs to a device under test (e.g., devices under test 8). In this way, simulation systems 4 may be configured to interact with the respective one of devices under test 8 such that devices under test 8 appear to be part of the emulated electrical network. The portion of the electrical system that is emulated by simulation systems 4 may include any number of pieces of basic electrical hardware, including resistors, capacitors, inductors, wires, and/or more complex electrical components, such as electric drives, generators, power plants, and others. In other words, simulation systems 4 may be capable of emulating a collection of almost any electrical components for virtual interaction with devices under test 8.

In the example of FIG. 2, devices under test 8 are physical electrical devices electrically coupled to simulation systems 4. For example, devices under test 8 may represent an electrical source, an electrical load, a grid management device, or any other electrical device. Devices under test 8 may be coupled to the respective one of simulation systems 4 via other electrical hardware. As shown in FIG. 2, for instance, devices under test 8 may be coupled to simulation systems 4 via a current source and a variable resistance. Simulation systems 4 may relay information to devices under test 8 by modifying the current output by the current source and/or the size of the variable resistance. Simulation systems 4 may also receive information from devices under test 8 by monitoring the current and/or voltage drawn by devices under test 8. In this way, simulation systems 4 may cause devices under test 8 to react as if devices under test 8 were part of the electrical system emulated by simulation systems 4.

In the example of FIG. 2, simulation system 4A, observer 6A, and device under test 8A are all collocated. That is, they are all located in the same place. Similarly, simulation system 4B, observer 6B, and device under test 8B are all collocated. However, simulation system 4A, observer 6A, and device under test 8A are physically remote from simulation system 4B, observer 6B, and device under test 8B. That is, the left side of FIG. 2 may represent one simulation system and the right side of FIG. 2 may represent a second, remote simulation system. Simulation system 4A may emulate a first portion of the electrical system and simulation system 4B may emulate a second portion of the electrical system.

In the example of FIG. 2, simulation systems 4 may communicate with one another via one or more networks 10 in order to simulate the complete electrical system. Networks 10 may represent any number of communication networks, including wired and wireless networks, as well as intranets, the Internet, or any other communication network. By relaying information to one another via networks 10, each of simulation systems 4 may use data about the state of the other's emulated portion in its own emulated portion. However, because information does not travel instantaneously, state information (e.g., emulation values) from one of simulation systems 4 may be incorrect by the time it reaches the other of simulation systems 4. That is, the emulation values exchanged between simulation systems 4 may be delayed.

In the example of FIG. 2, observers 6 are configured to receive a delayed version of at least one remote emulation value, determine, based on the delayed version of the at least one remote emulation value and a model of the corresponding portion of the electrical system, a respective real-time estimation of the at least one remote emulation value, and output the respective real-time estimation of the at least one remote emulation value. That is, observers 6 are configured to determine an estimate of the other simulation system's real-time emulated state based on a delayed version of the other simulation system's real-time emulated state and a local model of the other simulation system's emulated portion of the electrical system. Simulation systems 4 may then use the estimate of the real-time state of one another to emulate their respective portion of the electrical system.

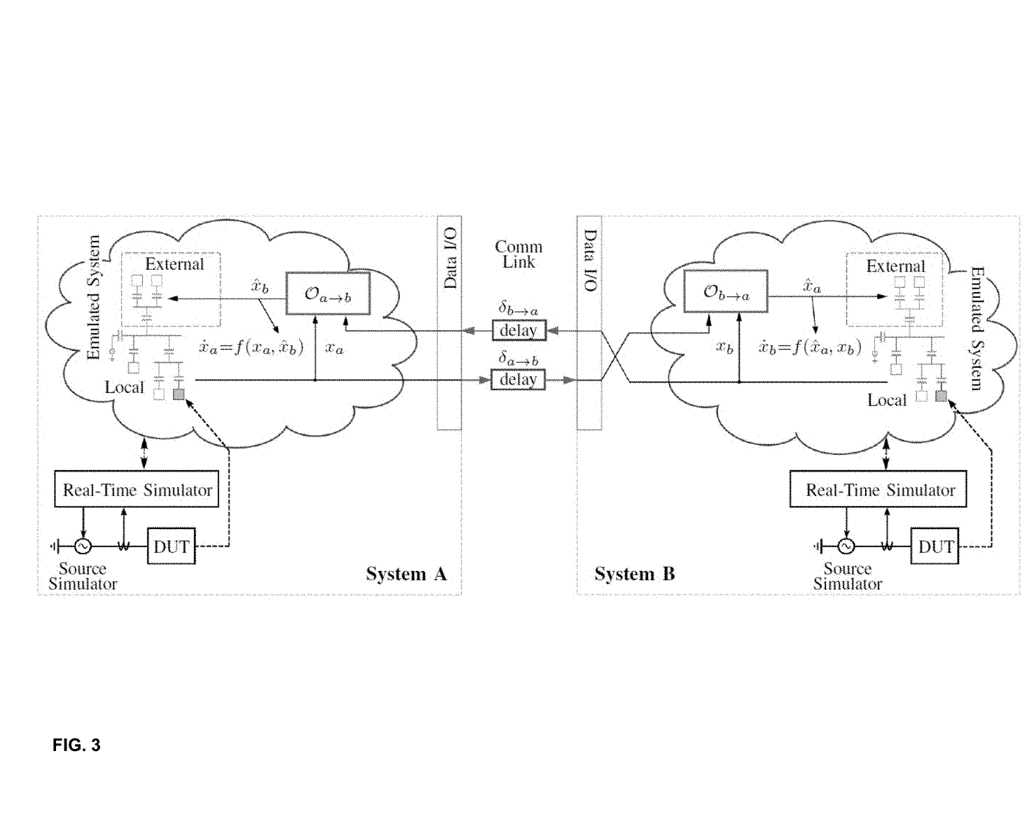

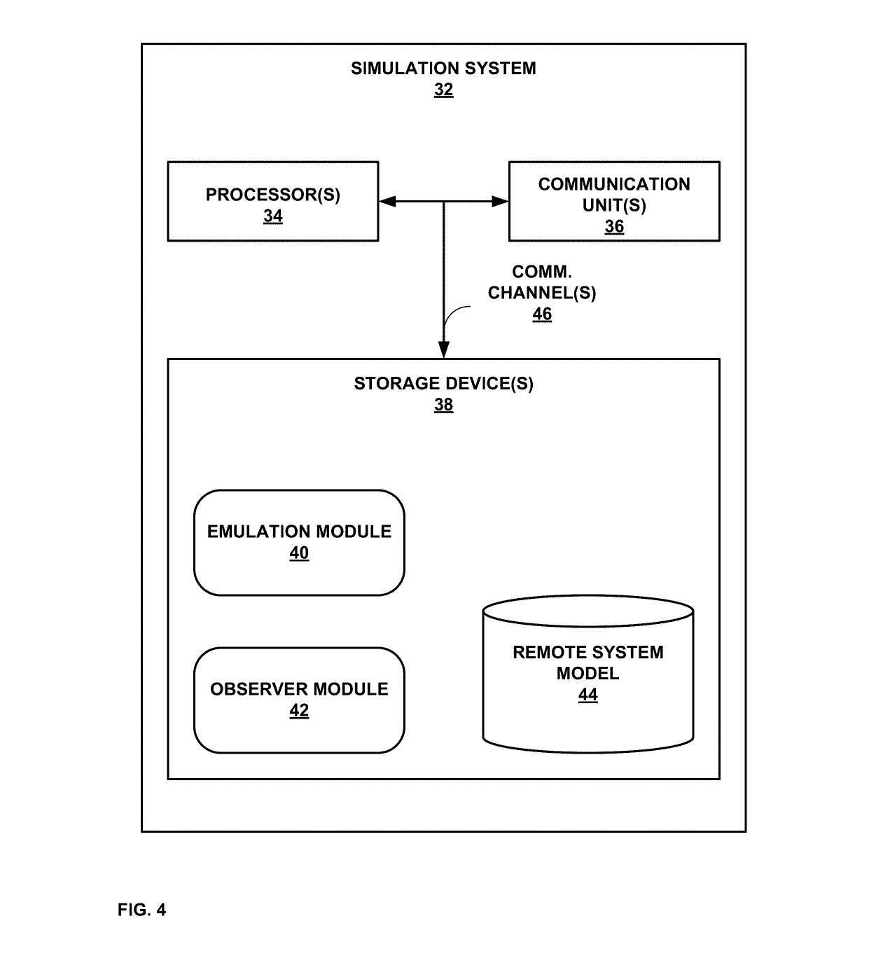

In this way, observers 6 may reduce or mitigate potential problems arising from the delays inherent in communication across large distances. As one example, without observers 6, simulation systems 4 may attempt to emulate their respective portions of the electrical system based on incorrect values of the other's state, leading to erroneous operation and inaccurate results. By using the delayed state information and a model to estimate current state information, observers 6 may allow simulation systems 4 to more accurately emulate their respective portion of the electrical system and thereby produce more accurate results in HIL experiments. Further details of simulation systems 4 and observers 6 are described below with respect to FIGS. 3 and 4.

FIG. 3 is a schematic diagram illustrating another example configuration for mitigating latency errors in distributed HIL simulation systems, in accordance with one or more aspects of the present disclosure. In the example of FIG. 3 delayed measurements from a remote system along with knowledge of a mathematical representation of the remote system are used to determine an estimate of the current (non-delayed) remote states. Errors in the predicted states may then be dynamically corrected as new information is obtained from the remote system.

The assumptions implicit in the use of the techniques described herein are a) an accurate model of the device(s) under test can be acquired at the remote location and utilized to synthesize the observer(s), and b) the datasets utilized as inputs to the HIL experiments (e.g., solar irradiance, load profiles, etc.) are available and synchronized at both locations.

The delay compensation methodology described herein (also referred to herein as the Observer Delay Compensation (ODC) approach) makes use of the notion of drift observability of a (non)linear system, and leverages methods for synthesizing observers for dynamical systems with delayed measurements.

The techniques of the present disclosure are described herein using the following notation. Upper-case (lower-case) boldface letters will be used for matrices (column vectors); and, (•)^{T} for transposition. |•| denotes the absolute value of a number or the cardinality of a set; ∇ stands for the gradient operator; and, [symbol] x, y [symbol] denotes inner product of vectors x and y. For a given N×1 vector xε [symbol] ⁿ, xᵢ denotes its ith component, and ∥x∥₂:=\sqrt{x^{T}x}, [symbol] ^{∞} denotes the set of natural numbers (strictly positive integers).

Consider the following nonlinear dynamical system describing the evolution of a state vector x(t)ε [symbol] ⁿ.

\dot{x}(t)=f(x(t))+g(x(t))u(t) (1)

\ddot{y}(t)=h(x(t−δ(t))) (2)

where u(t)ε [symbol] ^{m} is a known input vector, functions f: [symbol] ⁿ→ [symbol] ⁿ, g: [symbol] ⁿ× [symbol] ^{m}→ [symbol] ⁿ, and h: [symbol] ⁿ→ [symbol] are in [symbol] ^{∞}, and y̅(t) represents a measurement of the delayed state x at time t−δ(t) of the system output y(t)=h(x(t)). Particularly, δ(t)ε[0,Δ], ∀t represents a known, time-varying and bounded measurement delay. The objective is to design an observer that predicts the system state x(t) by processing the delayed measurements y̅(t).

Let ξ: [symbol] ⁿ→ [symbol] be an infinitely differentiable function, and consider a vector field v: [symbol] → [symbol] ⁿ, [symbol] ⊂ [symbol] ⁿ. Suppose that v(x)ε [symbol] ^{∞}. Then, the Lie derivative of function [symbol] (x) along the vector field v is defined as the following inner product:

$${L}_{v} ξ ( x ) = 〈 ∇ ξ ( x ) , v ( x ) 〉 = {\sum }_{i = 1}^{n} \frac{\partial ξ ( x )}{\partial {x}_{i}} {v}_{i} ( x ) \qquad ( 3 )$$

The kth Lie derivative of ξ(x), denoted Lᵥ^{k}ξ(x), is obtained by k-times repeated iteration of Lᵥξ(x), Lᵥ⁰ξ(x):=ξ(x).

Consider the following mapping associated with functions f(•) and h(•) in (1):

Φ(x):=[h(x)L_{f}h(x) . . . L_{f}ⁿ⁻¹h(x)]^{T}. (4)

System (1) is said to be globally drift-observable if Φ(x) is a diffeomorphism (defined below) on [symbol] ⁿ. Drift-observability of (1) implies that the Jacobian J(x) associated with Φ(x) is nonsingular for all xε [symbol] ⁿ, in which case the mapping z=Φ(x) defines a global change of coordinates.

Suppose that system (1) is globally drift-observable, and has the following additional properties:

(P1) The triple (f,g,h) has uniform observation degree at least equal to n defined as:

L_{g}L_{f}^{k}h(x)=0,k=, . . . ,n−2,∀xε [symbol] ⁿ (5)

L_{g}L_{f}ⁿ⁻¹h(x)≠0, for some xε [symbol] ⁿ, (6)

in which case, the following function is well defined: (6)

p(z,u)=L_{f}ⁿh(x)+L_{g}L_{f}ⁿ⁻¹h(x)u)_{x=Φ}_{^{−1}}_{(z)}, (7)

(P2) Function p(z,u) in (7) is globally uniformly Lipschitz continuous with respect to z, and the Lipschitz coefficient γ(∥u∥) is a non-decreasing function of ∥u∥; i.e., for any z₁, z₂ε [symbol] ⁿ, it holds that

∥p(z₁,u)−p(z₂,u)∥≦γ(∥u∥)∥z₁−z₂∥. (8)

If (1) is globally uniformly Lipschitz drift-observable (“GULDO”) with properties (P1) and (P2), then the following observer associated with system (1) can be constructed:

\hat{x}(t)=f(\hat{x}(t))+g(\hat{x}(t)u(t))+J⁻¹(\hat{x}(t))k_{δ}[y̅(t)−h(\hat{x}(t−δ(t)))],t≧0 (9a)

k_{δ}=e^{-ρ5}k₀ (9b)

where vector k₀ε [symbol] ⁿ and ρ≧0 are design parameters. A theorem from the literature asserts that if input ∥u(t)∥≦uₘ for some constant uₘ, then for a decay rate ρ≧0 and bounded delay δ(t)ε[0,Δ] there exists a vector k₀ε [symbol] ⁿ such that

∥x(t)−\hat{x}(t)∥≦ce^{-ρt},t≧0 (10)

for some constant c. That is, \hat{x}(t) asymptotically converges to the actual (non-delayed) system state x(t). Furthermore, the theorem states that if vector k₀ satisfies matrix inequality

(Aₙ−k₀Cₙ)^{T}P+P(Aₙ−k₀Cₙ)+ (11)

(2ρ+β+n)P+γ_{M}²(Bₙ^{T}PBₙ)I_{n×n}≦0, (12)

where (Aₙ, Bₙ, Cₙ) are a Brunowski triple of order n, γₘ is the Lipschitz coefficient associated with uₘ, β>0 and κ>1 design parameters, and P is symmetric positive definite, then exponential-decay state tracking is guaranteed for

Δ≦Δ̅=β/2+(k₀^{T}Pk₀)∥P⁻¹∥(1+ρ2+Cₙ²k₁²)_{κ}. (13)

As shown in the example of FIG. 3, the mathematical description of System A (or System B) is a function of both internal (e.g., locally measured or determined) state information x_{a(b)} and estimates of remote states \hat{x}_{b(a)}. Estimates for remote states occurring at System A (or System B) are determined by observers located at System B (or System A). The notation θ_{x→y} denotes an observer at System X that estimates delayed states received from System Y. δ_{x→y} denotes the communication delay between System X and System Y.

FIG. 4 is a block diagram illustrating one example of a simulation system (e.g., simulation system 32) configured to mitigate latency errors, in accordance with one or more aspects of the present disclosure. Simulation system 32 may include hardware and firmware or software. In the example of FIG. 4, simulation system 32 may comprise a hardware device, such as a real-time simulation device, having various hardware, firmware, and software components. However, FIG. 4 illustrates only one particular example of simulation system 32, and many other examples of a simulation system configured to mitigate latency errors may be used in accordance with techniques of the present disclosure. In the example of FIG. 4, simulation system 32 represents a single system configured to mitigate latency errors. In other examples, one or more components of simulation system 32 may be physically separate from one another. That is, in some examples, for instance, one or more components of simulation system 32 may be executed by separate devices.

As shown in the specific example of FIG. 4, simulation system 32 includes one or more processors 34, one or more communications units 36, and one or more storage devices 38. Simulation system 32 further includes emulation module 40, observer module 42, and remote system model 44. Each of components 34, 36, and 38 may be interconnected (physically, communicatively, and/or operatively) for inter-component communications. In the example of FIG. 4, for instance, components 34, 36, and 38 may be coupled via one or more communications channels (COMM. CHANNELS) 46. In some examples, communications channels 46 may include a system bus, network connection, inter-process communication data structure, or any other channel for communicating data. In other examples, such as where components of simulation system 32 are executed by separate devices, communications channels may include one or more network connections. Modules 40 and 42, as well as remote system model 44, may also communicate information with one another as well as with other components of simulation system 32.

Processors 34, in one example, are configured to implement functionality and/or process instructions for execution within simulation unit 32. For example, processors 34 may be capable of processing instructions stored in storage devices 38. Examples of processors 34 may include, any one or more of a microprocessor, a controller, a digital signal processor (DSP), an application specific integrated circuit (ASIC), a field-programmable gate array (FPGA), or equivalent discrete or integrated logic circuitry.

Simulation unit 32, in the example of FIG. 4, also includes communication units 36. Simulation unit 32, in one example, utilizes one or more communication units 36 to communicate with external devices via one or more networks (e.g., networks 10 of FIG. 2). As such, communication units 36 may include a network interface card, such as an Ethernet card, an optical transceiver, a radio frequency transceiver, or any other type of device that can send and receive information. Other examples of such network interfaces may include Bluetooth, 3G and WiFi radio components as well as Universal Serial Bus (USB). Communications units 36 may also include components for communicating with a device under test. For instance, communications units 36 may include voltage, resistance, and/or current control units that are able to output electrical signals as a way of interacting with a device under test.

In some examples, simulation system 32 utilizes communication units 36 to communicate with one or more external devices such as one or more other simulation systems and/or one or more devices under test. For instance, communication units 36 may receive state information from a physically remote simulation system indicating the state of an emulated portion of an electrical system, and provide the state information to one or more other components of simulation system 32 (e.g., observer module 42). As another example, communications units 36 may receive information regarding a state or operation of a device under test and provide such information to emulation module 40 and/or other components.

One or more storage devices 38 may be configured to store information within simulation system 32 during operation. Storage devices 38, in some examples, can be described as a computer-readable storage medium. In some examples, storage devices 38 are a temporary memory, meaning that a primary purpose of storage devices 38 is not long-term storage. Storage devices 38, in some examples, are described as a volatile memory, meaning that storage devices 38 do not maintain stored contents when the computer is turned off. Examples of volatile memories include random access memories (RAM), dynamic random access memories (DRAM), static random access memories (SRAM), and other forms of volatile memories known in the art. In some examples, storage devices 38 are used to store program instructions for execution by processors 34. Storage devices 38, in one example, are used by software or applications running on simulation system 32 (e.g., modules 40 and 42) to temporarily store information during program execution.

Storage devices 38, in some examples, also include one or more computer-readable storage media. In such examples, storage devices 38 may be configured to store larger amounts of information than volatile memory. Storage devices 38 may further be configured for long-term storage of information. In some examples, storage devices 38 include non-volatile storage elements. Examples of such non-volatile storage elements include magnetic hard discs, optical discs, floppy discs, flash memories, or forms of electrically programmable memories (EPROM) or electrically erasable and programmable memories (EEPROM).

In some examples, simulation system 32 may contain more or fewer components than those shown in FIG. 4. For instance, simulation system 32 may contain one or more input devices, such as devices configured to receive input from a user or administrator through tactile, audio, or video feedback, and/or one or more output devices, such as devices configured to provide output to a user or administrator using tactile, audio, or video stimuli.

In the example of FIG. 4, remote system model 44 may be data representing a mathematical model of a portion of an electrical system that is emulated by a remote simulation system. That is, remote system model 44 may be, for example, a system of equations that specifies how the portion of the electrical system will react, when given certain inputs. For example, remote system model 44 may be a method or function that may be called, may be a table or spreadsheet of values, or may be data formatted in some other way. Regardless, one or more components of simulation system 32 may access remote system model 44 to obtain information about how the emulated portion will behave when given certain inputs.

In the example of FIG. 4, emulation module 40 may be executed by processors 34 to cause simulation system 32 to emulate a first portion of an electrical system and control electrical inputs to a device under test based on the emulated electrical system. Communications units 36 may receive, from another simulation system that is physically remote from simulation system 32, at least one remote emulation value. The at least one remote emulation value may represent the state of a second portion of the electrical system. That is, the other simulation system may be emulating a second portion of the electrical system and send the at least one remote emulation value to simulation system 32. Because the at least one remote emulation value was transmitted over some physical distance, the value received by simulation system 32 may be a delayed version. That is, what is received by communications units 36 necessarily will have been sent at an earlier time by the other simulation system. Communications units 36 may provide the delayed version of the at least one remote emulation value to observer module 42.

Observer module 42 may be executed by processors 34 to determine, based on the delayed version of the at least one remote emulation value and remote system model 44, a respective real-time estimation of the at least one remote emulation value. That is, observer module 42 may communicate with remote system model 44 and/or emulation module 40 to estimate a current state of the remotely emulated portion of the electrical system based on a mathematical model of the remotely emulated portion and/or the current state of the portion emulated by emulation module 40. Observer module 42 may provide the real-time estimation of the at least one remote emulation value to emulation module 40 for use in emulating its portion of the electrical system and/or controlling the device under test.

In this way, observer module 42 may mitigate latency errors inherent in distributed simulations, thereby allowing simulation system 32 to more accurately emulate how the electrical system and the device under test would interact. Additionally, while described herein as being emulated by two simulation systems, the techniques of the present disclosure may be employed to mitigate latency errors among any number of distributed simulation systems. In such examples, simulation system 32 may, for instance, include multiple remote system models, each corresponding to a different portion of the electrical system that are emulated by different simulation systems. In this way, the techniques described herein may allow for larger, more complex simulations than those that may be performed by a single machine while improving accuracy and precision.

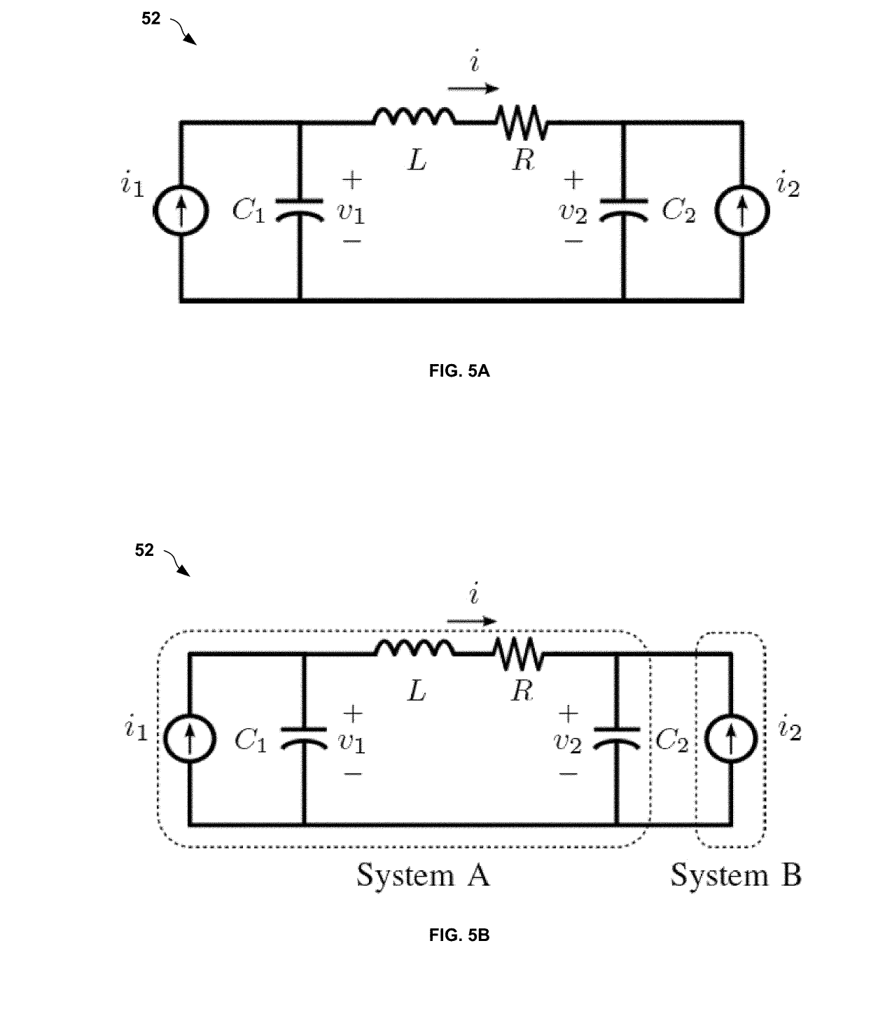

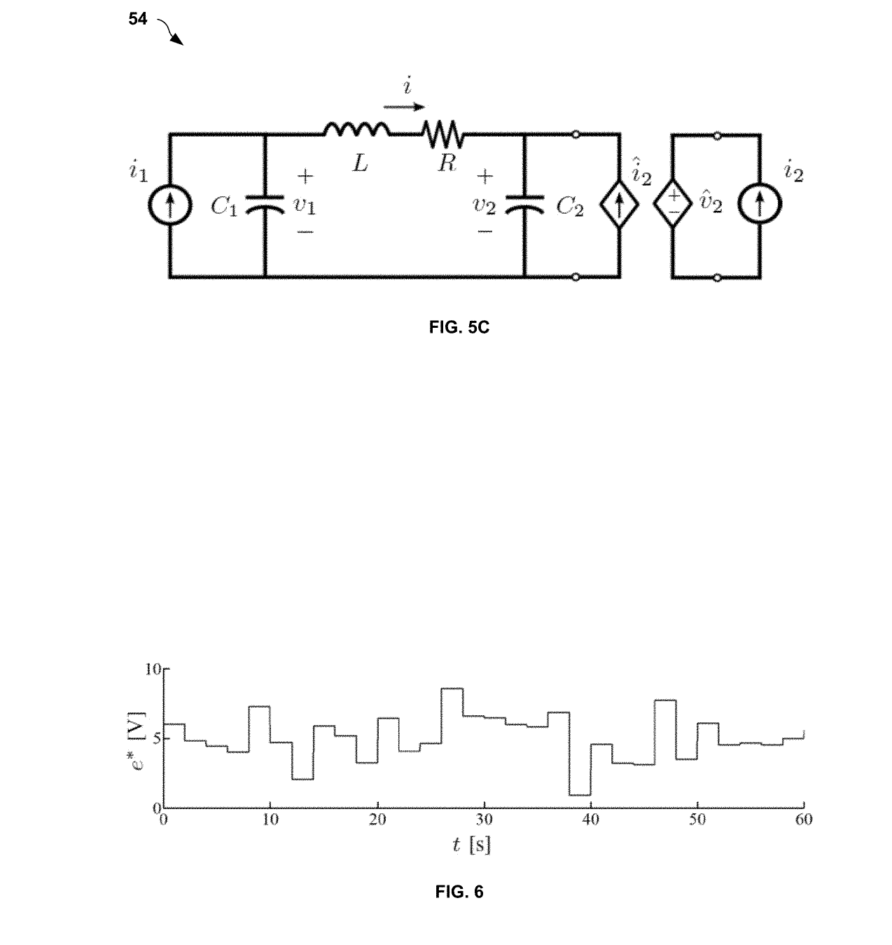

FIGS. 5A-5C are schematic diagrams illustrating an example distributed simulation of an electrical circuit, in accordance with one or more aspects of the present disclosure. The process described with respect to FIGS. 5A-5C represents one example of how the techniques described herein may be used to partition and virtually connect an example circuit.

As shown in FIG. 5A, an example circuit (e.g., circuit 52) includes two current sources, labeled i₁ and i₂. The current sources are laid out in parallel with shunt capacitors C₁ and C₂, respectively. The two current source and shut capacitor groupings are connected through a series RL impedance.

The equation describing each of the kε{1,2} sources is

$$\frac{{di}_{k}}{dt} = {η}_{k} ( {v}_{k} - {e}_{k}^{*} ) + {α}_{k} {i}_{k} , \qquad ( 14 )$$

where eₖ* are inputs for representing externally-connected sources, ηₖ are voltage error gains and αₖ are damping factors.

The system of circuit 52 can be represented in state-space form

$$\frac{dx}{dt} = Ax + Bu , \qquad ( 15 )$$

where the vector of states x=[i₁ i₂ v₁ v₂ i]r,

$$A = [ \begin{matrix}{α}_{1} & 0 & {η}_{1} & 0 & 0 \\ 0 & {α}_{2} & 0 & {η}_{2} & 0 \\ 1 / {C}_{1} & 0 & 0 & 0 & - 1 / {C}_{1} \\ 0 & 1 / {C}_{2} & 0 & 0 & 1 / {C}_{2} \\ 0 & 0 & 1 / L & - 1 / L & - R / L\end{matrix} ] , \\ B = [ \begin{matrix}- η & 0 \\ 0 & - {η}_{2} \\ 0 & 0 \\ 0 & 0\end{matrix} ] , \qquad ( 16 )$$

and the input vector u=[e₁*e₂*]^{T}.

As shown in FIG. 5B, circuit 52 may be partitioned into two separate portions, shown as “System A” and “System B” delineated in FIG. 5B by dashed lines. System A and System B may be simulated separately, yet remain coupled through mutual exchange of state information, in accordance with the techniques described herein.

FIG. 5C depicts circuit 54, which represents circuit 52 after physical separation and necessary modification. In circuit 54, with respect to System A, System B has been replaced with a controllable current source, labelled î₂, that injects an estimated input current into System A. With respect to System B, System A has been replaced with a controllable voltage source, labelled \hat{v}₂, that provides an estimated voltage to System B.

System A in FIG. 5C may be described in state-space as

$$\frac{{dx}_{a}}{dt} = {A}_{a} {x}_{a} + {B}_{a} {u}_{a} \qquad ( 17 )$$

where the vector of states x=[i₁ v₁ i v₂]^{T},

$${A}_{a} = [ \begin{matrix}{α}_{1} & {η}_{1} & 0 & 0 \\ 1 / {C}_{1} & 0 & - 1 / {C}_{1} & 0 \\ 0 & 1 / L & - R / L & - 1 / {C}_{1} \\ 0 & 0 & 1 / {C}_{2} & 0\end{matrix} ] , \\ {B}_{a} = [ \begin{matrix}- {η}_{1} & 0 \\ 0 & 0 \\ 0 & 0 \\ 0 & 1 / {C}_{2}\end{matrix} ] , \qquad ( 18 )$$

and the input vector uₐ=[e₁*î₂]^{T}. With the nominal output of System A at System A as v₂(t), the delayed output y̅ₐ(t)=v₂(t−δ(t)) in (1), is obtained by defining matrix Cₐ as:

$$\begin{matrix}{\overline{y}}_{a} ( t ) = {C}_{a} {x}_{a} ( t - δ ( t ) ) \\ = [ \begin{matrix}0 & 0 & 0 & 1\end{matrix} ] {x}_{a} ( t - δ ( t ) ) \\ = {v}_{2} ( t - δ ( t ) )\end{matrix} \qquad ( 19 )$$

For System B, the state-space representation is

$$\frac{{dx}_{b}}{dt} = {A}_{b} {x}_{b} + {B}_{b} {u}_{b} , \qquad ( 20 )$$

where the state vector x_{b}=[i₂],

A_{b}=[α₂],B_{b}=[−η₂η₂], (21)

and the input vector u_{b}=[e₂*\hat{v}₂]^{T}. With the nominal output of System B at System B as i₂(t), define the matrix C_{b} so that:

$$\begin{matrix}{\overline{y}}_{b} ( t ) = {C}_{b} {x}_{b} ( t - δ ( t ) ) \\ = [ 1 ] [ {i}_{2} ( t - δ ( t ) ) ] \\ = {i}_{2} ( t - δ ( t ) ) .\end{matrix} \qquad ( 22 )$$

Based on these models of System A and System B, observers may be designed to mitigate latency error in accordance with the techniques described herein. In some examples, the observers may be designed quasi-heuristically. For example, it can be assumed that if: (i) both Systems A and B (e.g., as shown in the example of FIG. 2 or in FIGS. 5A-5C) could be shown to be GULDO and possess properties (P1) and (P2) independently, (ii) observers are constructed for the system using (9) (which is always possible if the first condition is satisfied), and (iii) the upper bound on the communication delay between the two systems could be estimated with reasonable certainty, then: a set of observer design parameters may exist such that all states in the complete system converged asymptotically and furthermore, the observer designs could be validated for convergence through simulation.

These assumptions are based on the following: when designing an observer to estimate xε [symbol] ⁿ, N≦n states of a remote, n-dimensional system, (a) proof of drift-observability of the remote system ensures the Jacobian J(x) in (9) is non-singular for all xε [symbol] ⁿ, (b) the guarantee of observation degree ≧n ensures all remote states are observable, and (c) global uniform Lipschitz continuity ensures adjustment (e.g., feedback control) of states occurs along smooth and well-defined trajectories.

The observer at System A of FIGS. 5A-5C (e.g., θ_{a→b}) determines an estimated input current î₂ at System A based on measurements of signal i₂ (t−δ_{b→a}(t)) received from System B. To design such an observer, note from comparison of (1) and (20)-(22):

f(x(t)) [symbol] A_{b}×_{b}(t)=α₂i₂(t) (23)

g(x(t))u(t) [symbol] −η₂e₂*(t) (24)

h(x(t−δ(t)) [symbol] C_{b}×_{b}(t−δ(t))=i₂(t−δ(t)) (25)

The mapping z_{b}=Φ(x_{b}) for System B with n=1 is

Φ(x_{b})=x_{b}=i₂(t). (26)

Functions of the form Φ(x)=x,xε [symbol] are diffeomorphic (see proof below). Hence, Φ(x_{b}) is a diffeomorphism for x_{b}ε [symbol] . The Jacobian for System B

J_{b}(x_{b})=1 (21)

which is indeed non-zero for all x_{b}ε [symbol] .

It is necessary to examine whether remote System B possesses properties (P1) and (P2). For the first property, note that the first condition in (7) doesn't apply since n=1. The second condition is true since L_{g}L_{f}⁰h(x_{b})=η₂e₂*(t)≠0, for some x_{b}ε [symbol] ⁿ, in particular ∀t s.t. input e₂*(t)≠0. Note the function

$$\begin{matrix}p ( {z}_{b} , {u}_{b} ) = {( {L}_{f}^{n} h ( {x}_{b} ) + {L}_{g} {L}_{f}^{n - 1} h ( {x}_{b} ) {u}_{b} )}_{{x}_{b} = {Φ}^{- 1} ( {z}_{b} )} \\ = {α}_{2} {z}_{b} - {{η}_{2} ( {e}_{2}^{*} ( t ) )}^{2}\end{matrix} \qquad ( 28 )$$

is indeed well-defined. Considering property (P2) for System B, note that p(z_{b}, u_{b}) is globally uniformly Lipschitz continuous with respect to z_{b}. Its derivative with respect to z_{b} is equal to constant α₂ for all z_{b}ε [symbol] . The Lipschitz coefficient can be determined from the inequality

∥p(z_{b,1},u_{b})−p(z_{b,2},u_{b})∥=∥α₂∥∥z_{b,1}−z_{b,2}∥≦γ(∥u_{b}∥)∥z_{b,1}−z_{b,2}∥ (29)

From which the requirement can be derived that γ≧∥α₂∥.

The observer can now be constructed according to (9):

$$\frac{d {\hat{i}}_{2} ( t )}{dt} = {A}_{b} {\hat{i}}_{2} ( t ) + {B}_{b} {u}_{b} + {J}_{b}^{- 1} ( {\hat{i}}_{2} ( t ) ) {k}_{0} {e}^{- ρ δ} ( {i}_{2} ( t - {δ}_{b -> α} ( t ) ) - {\hat{i}}_{2} ( t - {δ}_{b -> α} ( t ) ) ) , \qquad ( 30 )$$

where the vector k₀ in (30) is determined using the standard method of obtaining a feedback vector for eigenvalue placement in Luenberger observers, which is always possible when the system is observable. This may be done, for example, to avoid reliance on the convergence guarantee in (12) and (13).

The observer at System B may be designed in a similar fashion. The observer at System B of FIGS. 5A-5C (e.g., θ_{b→a}) determines an estimated voltage \hat{v}₂(t) based on measurements of signal v₂(t−δ_{b→a}(t)) received from System A. To design such an observer, note from comparison of (1) and (17)-(19) that

f(x(t)) [symbol] Aₐxₐ(t) (31)

g(x(t))u(t) [symbol] [−η₁e₁*(t)0 0 0]^{T} (32)

h(x(t−δ(t))) [symbol] Cₐxₐ(t−δ(t))=v₂(t−δ(t)) (33)

The mapping z_{b}=Φ(x) for System A, with n=4 in (4)

$$Φ ( {x}_{a} ) = [ \begin{matrix}0 & 0 & 0 & 1 \\ 0 & 0 & 1 / {C}_{2} & 0 \\ 0 & 1 / {LC}_{2} & - R / {LC}_{2} & - 1 / {LC}_{2} \\ {σ}_{2} & {σ}_{2} & {σ}_{3} & {σ}_{4}\end{matrix} ] {x}_{a} := {Λ}_{a} {x}_{a} , \qquad ( 34 )$$

where σ₁=1/LC₁C₂,σ₂=1/LC₁C₂−R/L²C₂,σ₃=R²/L²C₂−1/LC₂², and σ₄=R/L²C₂. The mapping Φ(x) can be shown to be diffeomorphic if Aₐ is invertible (see proof below). From (34),

$${J}_{a} ( {x}_{a} ) = [ \begin{matrix}0 & 0 & 0 & 1 \\ 0 & 0 & 1 / {C}_{2} & 0 \\ 0 & 1 / {LC}_{2} & - R / {LC}_{2} & - 1 / {LC}_{2} \\ {σ}_{2} & {σ}_{2} & {σ}_{3} & {σ}_{4}\end{matrix} ] = {Λ}_{a} , \qquad ( 35 )$$

which is indeed non-zero for all xₐε [symbol] ⁴. For property (P1), it is easy to verify that L_{g}L_{f}^{k}h(x)=0 for k=0, . . . , n−2, ∀xε [symbol] ⁿ. The second condition in (P1) holds since L_{g}L_{f}³h(x)=Γg(x(t))u(t) where Γ:=[ζ₁ ζ₂ ζ₃ ζ₄], ζ₁=1/C₁C₂,ζ₂=−R/L²C₂,ζ₃=(−1/LC₁C₂+R²/L²C₂−1/L²C₂), and ζ₄=R/L²C₂. Therefore, L_{g}L_{f}³h(xₐ)=−η₁ζ₁e₁*(t)≠0 for some Xₐε [symbol] ⁴, in particular for any xₐε [symbol] ⁴ when the signal e₁*(t)≠0. As expected, p(zₐ,uₐ) is well defined:

$$\begin{matrix}p ( {z}_{a} , {u}_{a} ) = {( {L}_{f}^{4} h ( {x}_{a} ) + {L}_{g} {L}_{f}^{3} h ( {x}_{a} ) {u}_{a} )}_{{x}_{a} = {Φ}^{- 1} ( {z}_{a} )} \\ = Γ {x}_{a} - {η}_{1} {{ϛ}_{1} ( {e}_{1}^{*} ( t ) )}^{2} \\ = Γ {Λ}_{a}^{- 1} {z}_{a} - {η}_{1} {{ϛ}_{1} ( {e}_{1}^{*} ( t ) )}^{2} .\end{matrix} \qquad ( 36 )$$

Considering property (P2) for System A, note that p(zₐ,uₐ) is globally uniformly Lipschitz continuous with respect to z_{b} since its derivative with respect to this variable is equal to ΓAₐ⁻¹ for all z_{b}ε [symbol] ⁴. The Lipschitz coefficient can be determined from (8) to derive the requirement that γ≧∥ΓAₐ⁻¹∥.

The observer can be constructed according to (9):

$$\frac{d {\hat{x}}_{a}}{dt} = {A}_{a} {\hat{x}}_{a} ( t ) + {B}_{a} {u}_{a} + {J}_{a }^{- 1} ( {\hat{x}}_{a} ( t ) ) {k}_{0} {e}^{- ρ δ} ( {v}_{2} ( t - {δ}_{a -> b} ( t ) ) - {\hat{v}}_{2} ( t - {δ}_{a -> b} ( t ) ) ) , \qquad ( 37 )$$

where \hat{x}ₐ=[î₁ \hat{v}₁ î\hat{v}₂]^{T} and where vector k₀ in (37) is again found using the Luenberger observer design approach.

The techniques of the present disclosure were applied to a simulated version of circuit 54 of FIG. 5C using the parameter values shown in Table I below. In the simulation, the electrical circuit and controls were modeled using MathWorks® SimPowerSystems™ toolbox, version 5.7, available from The MathWorks, Inc. of Natick, Mass., United States.

TABLE I
Simulation Parameters

| Parameter | Value | |
|---|---|---|
| Capacitances, C₁, C₂ | 1.0 | [F] |
| Resistance, R | 0.5 | [Ω] |
| Inductance, L | 1.0 | [H] |
| Voltage Error Gain, η₁ | −1.0 | [sΩ]⁻¹ |
| Voltage Error Gain, η₂ | −1.0 | [sΩ]⁻¹ |
| Damping Factor, α₁ | −1.0 | [s]⁻¹ |
| Damping Factor, α₂ | −1.0 | [s]⁻¹ |
| Communication Delay, T_{d} | 0.20 | [s] |
| External Command Update Rate, τᵤ | 2.0 | [s] |
| Observer Convergence Rate, ρ | 4.0 | [ms] |

The passive circuit elements, error gains, and damping factors in Table I were chosen arbitrarily. The update rate τᵤ was chosen to be an order of magnitude greater than T_{d}. The desired convergence rate ρ was an arbitrarily chosen observer design parameter. The communication delay T_{d} was chosen to be several times greater than the empirically measured network delay (approximately 30 ms per round trip). The vector k₀ was determined to be [1] for θ_{a→b} and [4.06 6.18 4.18 1.06]^{T} for θ_{b→a}.

FIG. 6 is a graphical plot illustrating an input reference signal for the example distributed simulation of the circuit shown in FIG. 5C, in accordance with one or more aspects of the present disclosure. Both of the input signals e₁*(t) and e₂*(t), representing external sources in (14), were set equal to the input reference signal shown in FIG. 6. The input reference signal simply held a randomly sampled constant value that was updated every time interval τᵤ after the start of the simulation.

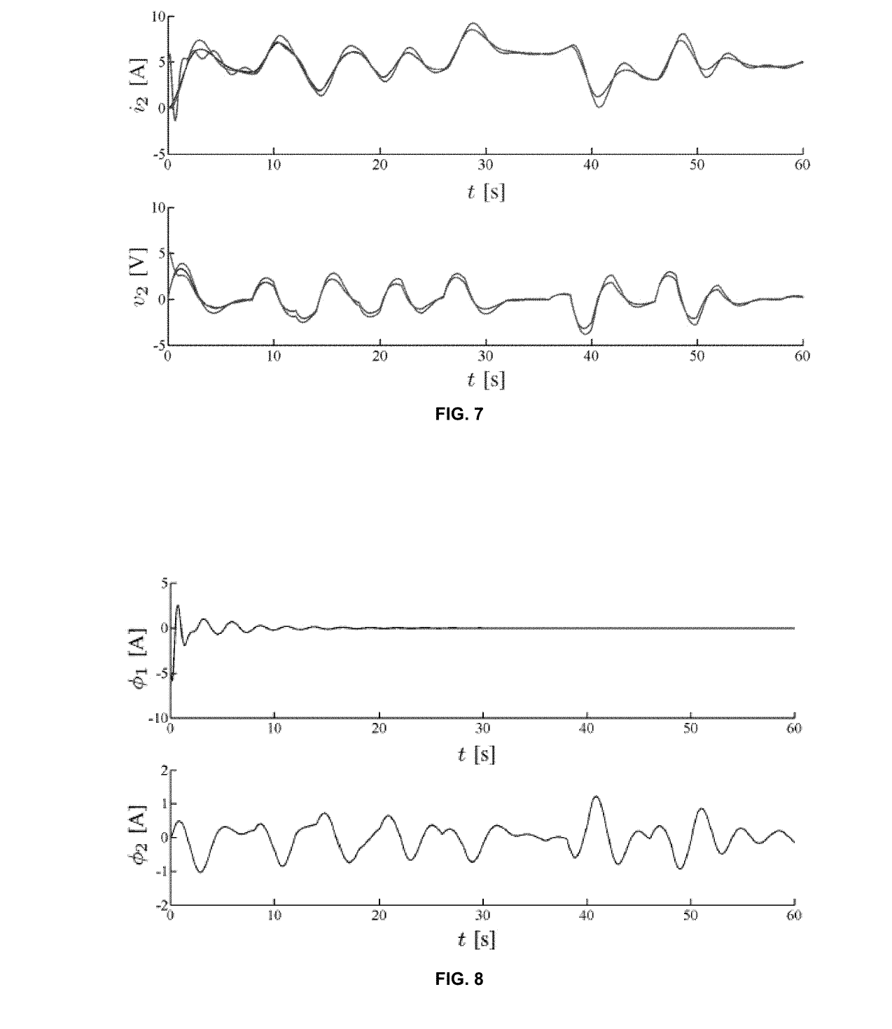

FIG. 7 is a set of graphical plots illustrating latency error mitigation results from the example distributed simulation of the circuit shown in FIG. 5C, in accordance with one or more aspects of the present disclosure. In FIG. 7, one set of lines represent the ideal response (e.g., from the ideal circuit of FIG. 5A). Another set of lines represent the uncompensated response and a third set of lines represent the observer output. As can be seen in FIG. 7, the ideal and observer based (“compensated”) signals converge for both voltage and current, despite continued changes in the input signals e₁*(t)=e₂*(t)=e*(t) throughout the simulation.

FIG. 8 is a set of graphical plots illustrating mitigated latency error values for the example distributed simulation of the circuit shown in FIG. 5C, in accordance with one or more aspects of the present disclosure. FIG. 8 represents the error between the compensated and uncompensated responses for the current i₂. In particular, φ₁(t) is the difference between the compensated and ideal response and φ₂ (t) is the difference between the uncompensated and ideal response.

As shown in FIG. 8, the error in the compensated current signal decreases exponentially to zero, as predicted by (10). Once the controller error converges to zero, it stays at zero even after the external inputs e₁*(t) and e₂*(t) continue to change. This was likely due to the fact that models for the full and partitioned systems were known exactly.

The techniques of the present disclosure were also experimentally validated in hardware. During this hardware-based experiment, a closed-loop, remote HIL experiment emulating the system shown in FIG. 5C, employing the architecture shown in FIG. 3, was performed. This experiment provided a virtual connection of equipment physically located at the National Renewable Energy Laboratory (NREL) Energy Systems Integration Facility (ESIF) in Golden, Colo. USA with equipment located at the Powerhouse Energy Campus at Colorado State University (CSU) in Fort Collins, Colo. USA. The physical separation between these locations was approximately 115 km.

System A and System B portions of circuit 54 were simulated on Opal-RT real-time digital simulators, available from Opal-RT Technologies, Inc. of Montreal, Quebec Canada. System A was simulated at NREL and System B was simulated at CSU. The observers for both systems were executed on Arduino EtherDUE microcontrollers, located at each location and available from various manufacturers. The EtherDUE microcontrollers had a built-in Ethernet port in addition to analog and digital I/O channels.

Measurements and observer values were passed between collocated Opal-RT and Arduino microcontrollers using digital and analog I/O channels. State information was passed between remote locations through the EtherDUE boards using Ethernet communication. Synchronization between systems was implemented using algorithms on the Arduino boards in a master/slave hand-shaking configuration.

As previously described, selection of observer parameters and stability analysis for this experiment required an estimate of the network delay between Systems A and B. Since network delays between two systems are generally dependent on many factors (e.g., network load and routing algorithms), the delay was determined experimentally using repeated ping algorithms on the microcontrollers. The sample mean of the round-trip communication delay was found to be approximately 30 ms.

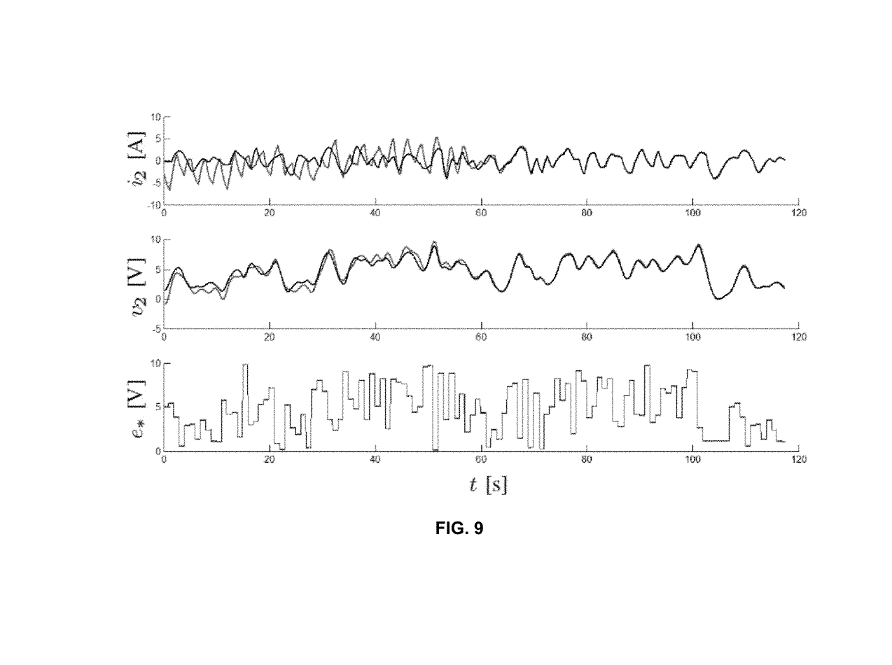

FIG. 9 is a set of graphical plots illustrating latency error mitigation results from the example distributed simulation in hardware of the circuit shown in FIG. 5C, in accordance with one or more aspects of the present disclosure. These measurements show that the compensated currents and voltages converged to the ideal response signals with little error after the delay compensation algorithms converged. Note that as predicted in simulation, once the observer based delay compensators converge, the error remains near zero even when the external input signal continues to change.

The following is a proof of diffeomorphisms for various mappings. Given two spaces [symbol] and [symbol] , a differential mapping f: [symbol] → [symbol] is a diffeomorphism if it is (i) bijective and (ii) the inverse mapping f⁻¹: [symbol] → [symbol] is differentiable.

As a proof of diffeomorphism for mapping f(x)=x, consider the mapping f: [symbol] → [symbol] defined by y=f(x)=x (i.e., the identity function). This map is differentiable with f′(x)=1. This map is bijective. That is, for each unique xε [symbol] there exist a unique yε [symbol] , and vice versa. The inverse map is also the identity function which, as stated previously, is differentiable. Thus, the mapping f(x)=x is a diffeomorphism.

As a proof of diffeomorphism for mapping f(x)=Ax, consider the mapping f: [symbol] ⁿ→ [symbol] ⁿ defined by y=f(x)=Ax,xε [symbol] ⁿ, yε [symbol] ⁿ, and A an n×n matrix where all elements [A]ᵢⱼ are constants. This map is differentiable with J_{f}=A, where J_{f} is the Jacobian on f. The map f is bijective if and only iff A has a well-defined inverse, A⁻¹. Assuming A⁻¹ exists, the inverse mapping is described by x=f⁻¹(y)=A⁻¹y, which is differentiable with J_{f}_{^{−1}}=A⁻¹. Thus, the mapping f(x)=Ax is a diffeomorphism if A is invertable.

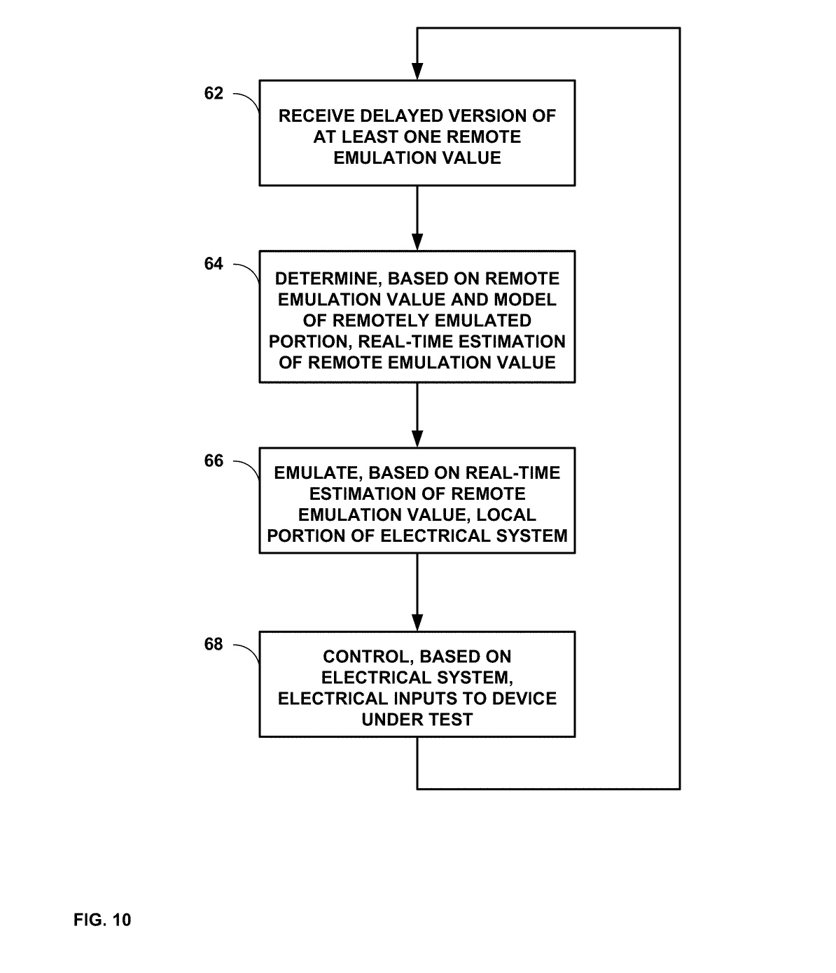

FIG. 10 is a flow diagram illustrating example operations for mitigating latency errors in distributed systems, in accordance with one or more aspects of the present disclosure. For purposes of illustration only, the example operations of FIG. 10 are described below within the context of FIG. 4.

In the example of FIG. 10, simulation system 32 may receive a delayed version of at least one remote emulation value (62). The at least one remote emulation value may represent a first portion of an electrical system generated by a simulation system that is physically separate from simulation system 32. That is, the at least one remote emulation value may correspond to a remotely-emulated portion of the electrical system. Simulation system 32 may determine, based on the at least one remote emulation value and a model of the first portion of the electrical system, a real-time estimation of the at least one remote emulation value (64).

In the example of FIG. 10, simulation system 32 may emulate, based on the real-time estimation of the at least one remote emulation value, a second portion of the electrical system (66). That is simulation system 32 may locally emulate another portion of the electrical system based at least in part on the real-time estimation of the state of the remotely emulated portion of the electrical system. Simulation system 32 may control, based on the electrical system, electrical inputs to a device under test (68). In this way, simulation system 32 may emulate interactions between the electrical system and the device under test in a more accurate fashion.

As shown in the example of FIG. 10, these operations may be repeated in a stepwise fashion such that system 32 regularly receives new remote emulation values, determines estimates of the real-time values, and emulates its portion of the electrical network based on those estimates. In this way, system 32 will regularly correct for any potential error that any individual estimate may cause.

In one example, a system configured to perform some or all of the operations described in the example of FIG. 10 may include a first simulation system configured to: emulate a first portion of an electrical system; and control, based on the first portion of the electrical system, electrical inputs to a device under test; and a first observation device operatively coupled to the first simulation system, the first observation device being configured to: receive a delayed version of at least one remote emulation value, the at least one remote emulation value representing a second portion of the electrical system, wherein the at least one remote emulation value is generated by a second simulation system that is physically separate from the first simulation system, determine, based on the delayed version of the at least one remote emulation value and a model of the second portion of the electrical system, a respective real-time estimation of the at least one remote emulation value, and output, to the first simulation system, the respective real-time estimation of the at least one remote emulation value, wherein the first simulation system is further configured to emulate the first portion of the electrical system based on the respective real-time estimation of the at least one remote emulation value.

In some examples, the at least one remote emulation value represents at least one first remote emulation value, the first observation device is further configured to: receive a delayed version of at least one second remote emulation value, the at least one second remote emulation value representing a third portion of the electrical system, wherein the at least one second remote emulation value is generated by a third simulation system that is physically separate from the first simulation system and the second simulation system; determine, based on the at least one second remote emulation value and a model of the third portion of the electrical system, a respective real-time estimation of the at least one second remote emulation value; and output, to the first simulation system, the respective real-time estimation of the at least one second remote emulation value, and the first simulation system is further configured to emulate the first portion of the electrical system based on the respective real-time estimation of the at least one second remote emulation value.

In some examples, the at least one remote emulation value represents at least one first remote emulation value, and the system further includes: the second simulation system, configured to: emulate the second portion of the electrical system; control, based on the second portion of the electrical system, electrical inputs to a second device under test; and output the at least one first remote emulation value; a second observation device operatively coupled to the second simulation system, the second observation device being configured to: receive, from the first simulation system, a delayed version of at least one second remote emulation value representing the first portion of the electrical system, determine, based on the at least one second remote emulation value and a model of the first portion of the electrical system, a respective real-time estimation of the at least one second remote emulation value, and output, to the second simulation system, the respective real-time estimation of the at least one second remote emulation value. The second simulation system may further be configured to emulate the second portion of the electrical system based on the respective real-time estimation of the at least one second remote emulation value.

In some examples, the first observation device is configured to determine the respective real-time estimation of the at least one remote emulation value further based on at least one local emulation value, the at least one local emulation value representing the first portion of the electrical system. In some examples, the first simulation system is configured to control the electrical inputs to the device under test by modifying at least one of an input current to the device under test or a resistance laid out in series with the device under test. In some examples, the electrical system represents a power system and the at least one remote emulation value is a voltage component and a current component.

In some examples, the first observation device is integrated with the first simulation system. In some examples, the system further includes the device under test.

In one example, a device configured to perform some or all of the operations described in the example of FIG. 10 may include at least one processor configured to: receive a delayed version of at least one remote emulation value, the at least one remote emulation value representing a first portion of an electrical system, wherein the at least one remote emulation value is generated by a simulation system that is physically separate from the computing device; determine, based on the delayed version of the at least one remote emulation value and a model of the first portion of the electrical system, a respective real-time estimation of the at least one remote emulation value; emulate, based on the respective real-time estimation of the at least one remote emulation value, a second portion of the electrical system; and control, based on the second portion of the electrical system, electrical inputs to a device under test.

In some examples, the at least one remote emulation value represents at least one first remote emulation value, the simulation system represents a first simulation system, the at least one processor is further configured to: receive a delayed version of at least one second remote emulation value, the at least one second remote emulation value representing a third portion of the electrical system, wherein the at least one second remote emulation value is generated by a second simulation system that is physically separate from the first simulation system and the computing device; determine, based on the delayed version of the at least one second remote emulation value and a model of the third portion of the electrical system, a respective real-time estimation of the at least one second remote emulation value; and emulate the second portion of the electrical system further based on the respective real-time estimation of the at least one second remote emulation value.

In some examples, the at least one processor is configured to determine the respective real-time estimation of the at least one remote emulation value further based on at least one local emulation value, the at least one local emulation value representing the first portion of the electrical system. In some examples, the at least one processor is configured to control the electrical inputs to the device under test by modifying at least one of an input current to the device under test or a resistance laid out in series with the device under test. In some examples, the electrical system represents a power system and the at least one remote emulation value represents a voltage component and a current component.

In one example, a method for performing some or all of the operations described in the example of FIG. 10 may include receiving, by a computing device comprising at least one processor, a delayed version of at least one remote emulation value, the at least one remote emulation value representing a first portion of an electrical system, wherein the at least one remote emulation value is generated by a simulation system that is physically separate from the computing device; determining, by the computing device and based on the delayed version of the at least one remote emulation value and a model of the first portion of the electrical system, a respective real-time estimation of the at least one remote emulation value; emulating, by the computing device and based on the respective real-time estimation of the at least one remote emulation value, a second portion of the electrical system; and controlling, by the computing device and based on the second portion of the electrical system, electrical inputs to a device under test.

In some examples, the at least one remote emulation value represents at least one first remote emulation value, the simulation system represents a first simulation system, and the method further includes: receiving a delayed version of at least one second remote emulation value, the at least one second remote emulation value representing a third portion of the electrical system, wherein the at least one second remote emulation value is generated by a second simulation system that is physically separate from the first simulation system and the computing device; and determining, based on the delayed version of the at least one second remote emulation value and a model of the third portion of the electrical system, a respective real-time estimation of the at least one second remote emulation value. The second portion of the electrical system may be emulated further based on the respective real-time estimation of the at least one second remote emulation value.

In some examples, the respective real-time estimation of the at least one remote emulation value is determined further based on at least one local emulation value, the at least one local emulation value representing the first portion of the electrical system. In some examples, controlling the electrical inputs to the device under test comprises modifying at least one of an input current to the device under test or a resistance laid out in series with the device under test.

In one or more examples, the techniques described herein may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media, which includes any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable storage medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of inter-operative hardware units, including one or more processors as described above, in conjunction with suitable software and/or firmware.

The foregoing disclosure includes various examples set forth merely as illustration. The disclosed examples are not intended to be limiting. Modifications incorporating the spirit and substance of the described examples may occur to persons skilled in the art. These and other examples are within the scope of this disclosure and the following claims.

What is claimed is:

1. A system comprising:
a first simulation system configured to:
emulate a first portion of an electrical system; and
control, based on the first portion of the electrical system, electrical inputs to a device under test; and
a first observation device operatively coupled to the first simulation system, the first observation device being configured to:
receive a delayed version of at least one remote emulation value, the at least one remote emulation value representing a second portion of the electrical system, wherein the at least one remote emulation value is generated by a second simulation system that is physically separate from the first simulation system,
determine, based on the delayed version of the at least one remote emulation value and a model of the second portion of the electrical system, a respective real-time estimation of the at least one remote emulation value, and
output, to the first simulation system, the respective real-time estimation of the at least one remote emulation value,
wherein the first simulation system is further configured to emulate the first portion of the electrical system based on the respective real-time estimation of the at least one remote emulation value.

2. The system of claim 1, wherein:
the at least one remote emulation value comprises at least one first remote emulation value,
the first observation device is further configured to:
receive a delayed version of at least one second remote emulation value, the at least one second remote emulation value representing a third portion of the electrical system, wherein the at least one second remote emulation value is generated by a third simulation system that is physically separate from the first simulation system and the second simulation system;
determine, based on the at least one second remote emulation value and a model of the third portion of the electrical system, a respective real-time estimation of the at least one second remote emulation value; and
output, to the first simulation system, the respective real-time estimation of the at least one second remote emulation value, and
the first simulation system is further configured to emulate the first portion of the electrical system based on the respective real-time estimation of the at least one second remote emulation value.

3. The system of claim 1, wherein the at least one remote emulation value comprises at least one first remote emulation value, and wherein the system further comprises:
the second simulation system, configured to:
emulate the second portion of the electrical system;
control, based on the second portion of the electrical system, electrical inputs to a second device under test; and
output the at least one first remote emulation value;
a second observation device operatively coupled to the second simulation system, the second observation device being configured to:
receive, from the first simulation system, a delayed version of at least one second remote emulation value representing the first portion of the electrical system,
determine, based on the at least one second remote emulation value and a model of the first portion of the electrical system, a respective real-time estimation of the at least one second remote emulation value, and
output, to the second simulation system, the respective real-time estimation of the at least one second remote emulation value,
wherein the second simulation system is further configured to emulate the second portion of the electrical system based on the respective real-time estimation of the at least one second remote emulation value.

4. The system of claim 1, wherein the first observation device is configured to determine the respective real-time estimation of the at least one remote emulation value further based on at least one local emulation value, the at least one local emulation value representing the first portion of the electrical system.

5. The system of claim 1, wherein the first simulation system is configured to control the electrical inputs to the device under test by modifying at least one of an input current to the device under test or a resistance laid out in series with the device under test.

6. The system of claim 1, wherein the electrical system comprises a power system and wherein the at least one remote emulation value comprises a voltage component and a current component.

7. The system of claim 1, wherein the first observation device is integrated with the first simulation system.

8. The system of claim 1, further comprising the device under test.

9. A device comprising:
at least one processor configured to:
receive a delayed version of at least one remote emulation value, the at least one remote emulation value representing a first portion of an electrical system, wherein the at least one remote emulation value is generated by a simulation system that is physically separate from the computing device;
determine, based on the delayed version of the at least one remote emulation value and a model of the first portion of the electrical system, a respective real-time estimation of the at least one remote emulation value;
emulate, based on the respective real-time estimation of the at least one remote emulation value, a second portion of the electrical system; and
control, based on the second portion of the electrical system, electrical inputs to a device under test.

10. The device of claim 9, wherein:
the at least one remote emulation value comprises at least one first remote emulation value,
the simulation system comprises a first simulation system, and
the at least one processor is further configured to:
receive a delayed version of at least one second remote emulation value, the at least one second remote emulation value representing a third portion of the electrical system, wherein the at least one second remote emulation value is generated by a second simulation system that is physically separate from the first simulation system and the computing device;
determine, based on the delayed version of the at least one second remote emulation value and a model of the third portion of the electrical system, a respective real-time estimation of the at least one second remote emulation value; and
emulate the second portion of the electrical system further based on the respective real-time estimation of the at least one second remote emulation value.

11. The device of claim 9, wherein the at least one processor is configured to determine the respective real-time estimation of the at least one remote emulation value further based on at least one local emulation value, the at least one local emulation value representing the first portion of the electrical system.

12. The device of claim 9, wherein the at least one processor is configured to control the electrical inputs to the device under test by modifying at least one of an input current to the device under test or a resistance laid out in series with the device under test.

13. The device of claim 9, wherein the electrical system comprises a power system and wherein the at least one remote emulation value comprises a voltage component and a current component.

14. A method comprising:
receiving, by a computing device comprising at least one processor, a delayed version of at least one remote emulation value, the at least one remote emulation value representing a first portion of an electrical system, wherein the at least one remote emulation value is generated by a simulation system that is physically separate from the computing device;
determining, by the computing device and based on the delayed version of the at least one remote emulation value and a model of the first portion of the electrical system, a respective real-time estimation of the at least one remote emulation value;
emulating, by the computing device and based on the respective real-time estimation of the at least one remote emulation value, a second portion of the electrical system; and
controlling, by the computing device and based on the second portion of the electrical system, electrical inputs to a device under test.

15. The method of claim 14, wherein:
the at least one remote emulation value comprises at least one first remote emulation value,
the simulation system comprises a first simulation system,
the method further comprises:
receiving a delayed version of at least one second remote emulation value, the at least one second remote emulation value representing a third portion of the electrical system, wherein the at least one second remote emulation value is generated by a second simulation system that is physically separate from the first simulation system and the computing device; and
determining, based on the delayed version of the at least one second remote emulation value and a model of the third portion of the electrical system, a respective real-time estimation of the at least one second remote emulation value, and
the second portion of the electrical system is emulated further based on the respective real-time estimation of the at least one second remote emulation value.

16. The method of claim 14, wherein the respective real-time estimation of the at least one remote emulation value is determined further based on at least one local emulation value, the at least one local emulation value representing the first portion of the electrical system.

17. The method of claim 14, wherein controlling the electrical inputs to the device under test comprises modifying at least one of an input current to the device under test or a resistance laid out in series with the device under test.
